(19) United States
(12) Patent Application Publication
(10) Pub. No.: US 2008/0244117 A1
(43) Pub. Date: Oct. 2, 2008

(54) METHOD AND SYSTEM FOR DATA METERING

(76) Inventor: Edward Balassanian, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/933,047

(22) Filed: Oct. 31, 2007

Related U.S. Application Data
(63) Continuation of application No. 11/556,043, filed on Nov. 2, 2006.
Application No. 11/556,043 is a continuation of application No. 09/963,780, filed on Sep. 25, 2001, now abandoned.
(60) Provisional application No. 60/235,056, filed on Sep. 25, 2000.

(51) Int. Cl. G06F 3/00

(52) U.S. Cl. 710/50

(57) ABSTRACT

A method and system for tracking the type and amount of data processed by a computer system. In one embodiment, a logging system tracks data processed by a conversion system so that differential billing of customers can be performed based on the type of data and the quality of service required to provide that data. The logging system is integrated as part of the conversion system that converts the data from a source format into a target format. As the data is converted by the conversion routines, the logging system logs the amount of data that is converted by the conversion routines. Thus, the logging system is able to track the data at each conversion routine, such as each level of a communications protocol.

### CROSS REFERENCE TO RELATED APPLICATION(S)

The following application is incorporated by reference as if fully set forth herein: U.S. application Ser. No. 11/556,043 filed Nov. 2, 2006.

### TECHNICAL FIELD

The Present invention relates generally to a computer system for data metering.

### BACKGROUND

Computer systems, which are becoming increasingly pervasive, generate data in a wide variety of formats. The Internet is an example of interconnected computer systems that generate data in many different formats. Indeed, when data is generated on one computer system and is transmitted to another computer system to be displayed, the data may be converted in many different intermediate formats before it is eventually displayed. For example, the generating computer system may initially store the data in a bitmap format. To send the data to another computer system, the computer system may first compress the bitmap data and then encrypt the compressed data. The computer system may then convert that compressed data into a TCP format and then into an IP format. The IP formatted data may be converted into a transmission format, such as an Ethernet format. The data in the transmission format is then sent to a receiving computer system. The receiving computer system would need to perform each of these conversions in reverse order to convert the data in the bitmap format. In addition, the receiving computer system may need to convert the bitmap data into a format that is appropriate for rendering on output device.

In order to process data in such a wide variety of formats, both sending and receiving computer systems need to have many conversion routines available to support the various formats. These computer systems typically use predefined configuration information to load the correct combination of conversion routines for processing data. These computer systems also use a process-oriented approach when processing data with these conversion routines. When using a process-oriented approach, a computer system may create a separate process for each conversion that needs to take place. A computer system in certain situations, however, can be expected to receive data and to provide data in many different formats that may not be known until the data is received. The overhead of statically providing each possible series of conversion routines is very high. For example, a computer system that serves as a central controller for data received within a home would be expected to process data received via telephone lines, cable TV lines, and satellite connections in many different formats. The central controller would be expected to output the data to computer displays, television displays, entertainment centers, speakers, recording devices, and so on in many different formats. Moreover, since the various conversion routines may be developed by different organizations, it may not be easy to identify that the output format of one conversion routine is compatible with the input format of another conversion routine.

The data that is processed by a computer system, such as a central controller for a home, may have different types of quality of service (QOS) requirements. For example, certain type of text data may need to have its delivery guaranteed, but not the timeliness. In contrast, a stream of video data may need to have timeliness guaranteed, but some of the video frames can be dropped to ensure the timeliness. Network providers often charge their customers based on the amount of data transmitted over the network irrespective of the QOS required to deliver the data. For example, a customer who sends 10M bytes of video data might be charged the same as another customer who sends 10 M bytes of text data even though it is more “expensive” for the network provider to send the video data. It has been difficult for network providers to identify the type of data, amount of data, and QOS required to deliver data. The difficulty results, in part, from the data being layered in various communications protocols and from the data being sent in packets. It may be relatively easy for a network provider to track the amount of data sent, but it is very difficult for the network provider to decode the data in the different layers and to track the various packets as they are sent.

It would be desirable to have a technique in which the type and amount of data delivered by or to a network provider could be accurately determined. In addition, it would be desirable to have a technique for billing customers based on the type of data sent and received.

### BRIEF DESCRIPTION OF THE DRAWINGS

FIG. 1 is a block diagram illustrating example processing of a message by the conversion system.

FIG. 2 is a block diagram illustrating a sequence of edges.

FIG. 3 is a block diagram illustrating components of the conversion system in one embodiment.

FIG. 4 is a block diagram illustrating example path data structures in one embodiment.

FIG. 5 is a block diagram that illustrates the interrelationship of the data structures of a path.

FIG. 6 is a block diagram that illustrates the interrelationship of the data structures associated with a session.

FIGS. 7A, 7B, and 7C comprise a flow diagram illustrating the processing of the message send routine.

FIG. 8 is a flow diagram of the demux routine.

FIG. 9 is a flow diagram illustrating the log update routine in one embodiment.

FIG. 10 is a flow diagram of the process path routine in one embodiment.

FIG. 11 is a flow diagram of the queue message routine in one embodiment.

FIG. 12 is a flow diagram of the drop policy routine.

FIG. 13 is a flow diagram of the drop policy oldest routine.

FIG. 14 is a block diagram illustrating a data structure for storing logging information persistently in one embodiment.

### DETAILED DESCRIPTION

A method and system for tracking the type and amount of data processed by a computer system is provided. In one embodiment, a logging system tracks data processed by a conversion system so that differential billing of customers can be performed based on the type of data and the quality of service required to provide that data. The logging system is integrated as part of the conversion system that converts the data from a source format into a target format. For example, the conversion system may be part of a central controller for a home. As the data is converted by the conversion routines, the logging system logs the amount of data that is converted by the conversion routines. Thus, the logging system is able to track the data at each level of conversion, such as a communications protocol. For example, the logging system can track the number of HTTP messages that are processed and the size of graphic images that are processed. In addition, the logging system can track packets as they are aggregated or generated by a conversion routine. The process of identifying the type of data at each level is referred to as “branding.”

The branding and logging of data may enable different billing models to be used. In one embodiment, a user can be charged more for the delivery of the data (e.g., audio or video) that requires a high-level of quality of service. The branding and logging of data may also allow a network provider to distinguish data provided by various service providers. For example, an electrical company may want to read the electrical meters via the Internet, or a security company may want to collect video recordings via the Internet. In such cases, the conversion routines that ultimately process the electrical meter data and the security video data can be logged. The logged information can then be used to bill the electrical company and the security company for the amount and type of data that is transmitted across the network. In another embodiment, a network provider may use the logging information to track and bill for advertisements that are displayed to an end user. For example, a video feed of an advertisement may be sent by the advertiser to be displayed on an output device. The logging system would log information relating to the video feed, such as the length of video feed and advertiser. The billing system would then bill the advertiser based on the logged information.

The logging system is used in conjunction with a system for converting a message that may contain multiple packets from a source format into a target format. When a packet of a message is received, the conversion system in one embodiment searches for and identifies a sequence of conversion routines (or more generally message handlers) for processing the packets of the message by comparing the input and output formats of the conversion routines. (A message is a collection of data that is related in some way, such as stream of video or audio data or an email message.) The identified sequence of conversion routines is used to convert the message from the source format to the target format using various intermediate formats. The conversion system then queues the packet for processing by the identified sequence of conversion routines. The conversion system stores the identified sequence so that the sequence can be quickly found (without searching) when the next packet in the message is received. When subsequent packets of the message are received, the conversion system identifies the sequence and queues the packets for pressing by the sequence. Because the conversion system receives multiple messages with different source and target formats and identifies a sequence of conversion routines for each message, the conversion systems effectively “demultiplexes” the messages. That is, the conversion system demultiplexes the messages by receiving the message, identifying the sequence of conversion routines, and controlling the processing of each message by the identified sequence. Moreover, since the conversion routines may need to retain state information between the receipt of one packet of a message and the next packet of that message, the conversion system maintains state information as an instance or session of the conversion routine. The conversion system routes all packets for a message through the same session of each conversion routine so that the same state or instance information can be used by all packets of the message. A sequence of sessions of conversion routines is referred to as a “path.” In one embodiment, each path has a path thread associated with it for processing of each packet destined for that path.

In one embodiment, the packets of the messages are initially received by “drivers,” such as an Ethernet driver. When a driver receives a packet, it forwards the packet to a forwarding component of the conversion system. The forwarding component is responsible for identifying the session of the conversion routine that should next process the packet and invoking that conversion routine. When invoked by a driver, the forwarding component may use a demultiplexing (“demux”) component to identify the session of the first conversion routine of the path that is to process the packet and then queues the packet for processing by the path. A path thread is associated with each path. Each path thread is responsible for retrieving packets from the queue of its path and forwarding the packets to the forwarding component. When the forwarding component is invoked by a path thread, it initially invokes the first conversion routine in the path. That conversion routine processes the packet and forwards the processed packet to the forwarding component, which then invokes the second conversion routine in the path. The process of invoking the conversion routines and forwarding the processed packet to the next conversion routine continues until the last conversion routine in the path is invoked. A conversion routine may defer invocation of the forwarding component until it aggregates multiple packets or may invoke the forwarding component multiple times for a packet once for each sub-packet.

The forwarding component identifies the next conversion routine in the path using the demux component and stores that identification so that the forwarding component can quickly identify the conversion routine when subsequent packets of the same message are received. The demux component searches for the conversion routine and session that is to next process a packet. The demux component then stores the identification of the session and conversion routine as part of a path data structure so that the conversion system does not need to search for the session and conversion routine when requested to demultiplex subsequent packets of the same message. When searching for the next conversion routine, the demux component invokes a label map get component that identifies the next conversion routine. Once the conversion routine is found, the demux component identifies the session associated with that message by, in one embodiment, invoking code associated with the conversion routine. In general, the code of the conversion routine determines what session should be associated with a message. In certain situations, multiple messages may share the same session. The demux component then extends the path for processing that packet to include that session and conversion routine. The sessions are identified so that each packet is associated with the appropriate state information. The dynamic identification of conversion routines is described in U.S. patent application Ser. No. 09/304,973, filed on May 4, 1999, entitled “Method and System for Generating a Mapping Between Types of Data,” which is hereby incorporated by reference.

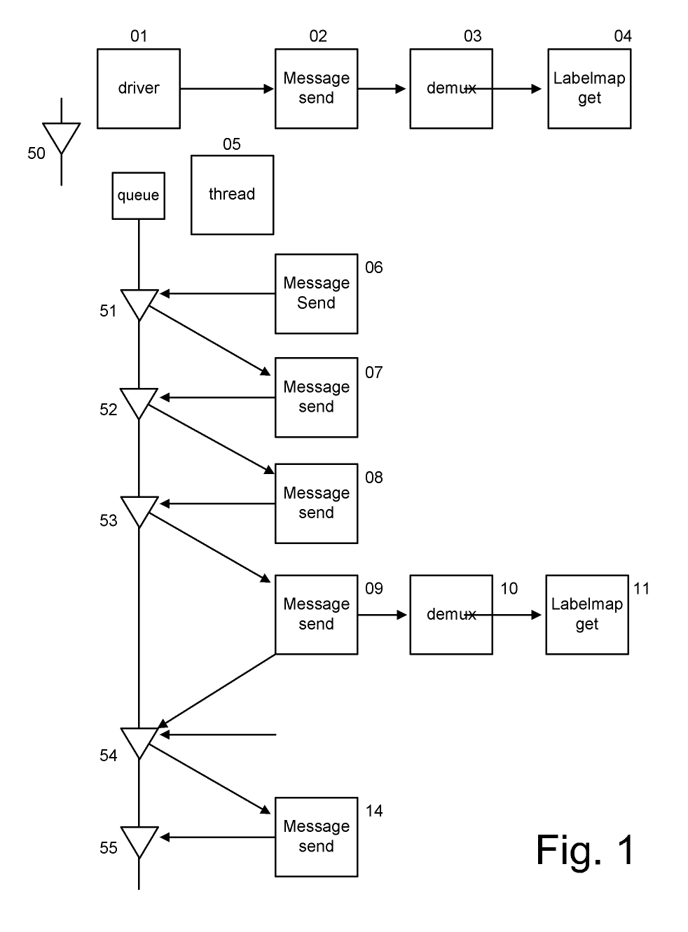

FIG. 1 is a block diagram illustrating example processing of a message by the conversion system. The driver 101 receives the packets of the message from a network. The driver performs any appropriate processing of the packet and invokes a message send routine passing the processed packet along with a reference path entry 150. The message send routine is an embodiment of the forwarding component. A path is represented by a series of path entries, which are represented by triangles. Each member path entry represents a session and conversion routine of the path, and a reference path entry represents the overall path. The passed reference path entry 150 indicates to the message send routine that it is being invoked by a driver. The message send routine invokes the demux routine 102 to search for and identify the path of sessions that is to process the packet. The demux routine may in turn invoke the label map get routine 104 to identify a sequence of conversion routines for processing the packet. In this example, the label map get routine identifies the first three conversion routines, and the demux routine creates the member path entries 151, 152, 153 of the path for these conversion routines. Each path entry identifies a session for a conversion routine, and the sequence of path entries 151-155 identifies a path. The message send routine then queues the packet on the queue 149 for the path that is to process the packets of the message. The path thread 105 for the path retrieves the packet from the queue and invokes the message send routine 106 passing the packet and an indication of the path. The message send routine determines that the next session and conversion routine as indicated by path entry 151 has already been found. The message send routine then invokes the instance of the conversion routine for the session. The conversion routine processes the packet and then invokes the message send routine 107. This processing continues until the message send routine invokes the demux routine 110 after the packet is processed by the conversion routine represented by path entry 153. The demux routine examines the path and determines that it has no more path entries. The demux routine then invokes the label map get routine 111 to identify the conversion routines for further processing of the packet. When the conversion routines are identified, the demux routine adds path entries 154, 155 to the path. The messages send routine invokes the conversion routine associated with path entry 154. Eventually, the conversion routine associated with path entry 155 performs the final processing for the path.

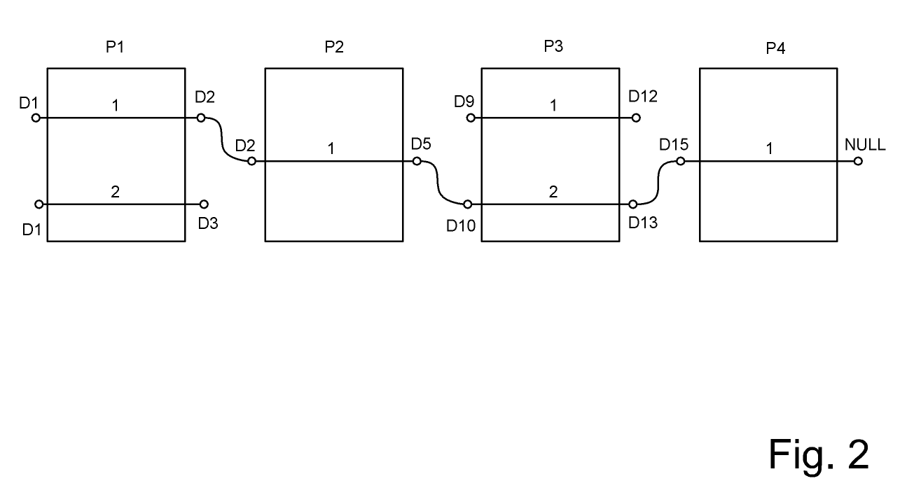

The label map get routine identifies a sequence of “edges” for converting data in one format into another format. Each edge corresponds to a conversion routine for converting data from one format to another. Each edge is part of a “protocol” (or more generally a component) that may include multiple related edges. For example, a protocol may have edges that each convert data in one format into several different formats. Each edge has an input format and an output format. The label map get routine identifies a sequence of edges such that the output format of each edge is compatible with the input format of another edge in the sequence, except for the input format of the first edge in the sequence and the output format of the last edge in the sequence. FIG. 2 is a block diagram illustrating a sequence of edges. Protocol P1 includes an edge for converting format D1 to format D2 and an edge for converting format D1 to format D3; protocol P2 includes an edge for converting format D2 to format D5, and so on. A sequence for converting format D1 to format D15 is shown by the curved lines and is defined by the address “P1:1, P2:1, P3:2, P4:7.” When a packet of data in format D1 is processed by this sequence, it is converted to format D15. During the process, the packet of data is sequentially converted to format D2, D5, and D13. The output format of protocol P2, edge 1 (i.e., P2:1) is format D5, but the input format of P3:2 is format D10. The label map get routine uses an aliasing mechanism by which two formats, such as D5 and D10 are identified as being compatible. The use of aliasing allows different names of the same format or compatible formats to be correlated.

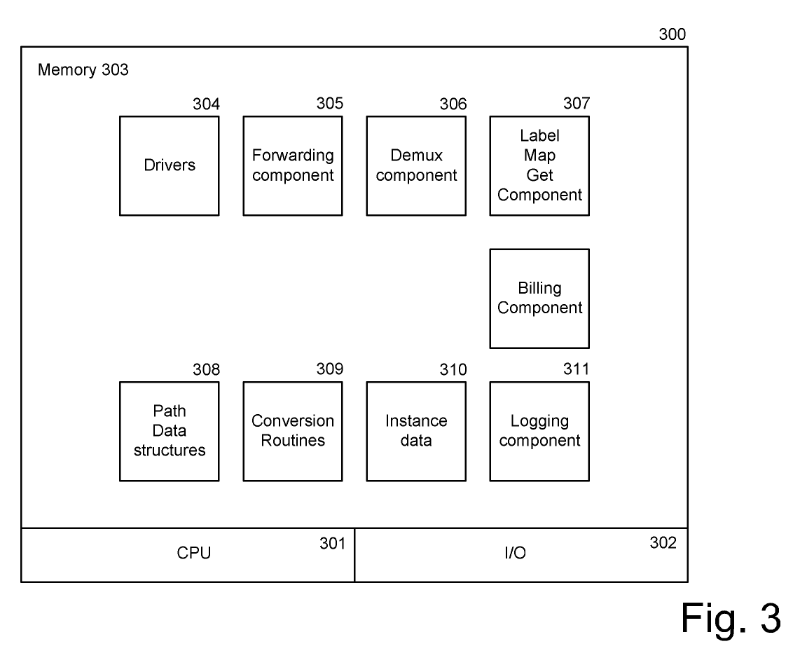

FIG. 3 is a block diagram illustrating components of the conversion system in one embodiment. The conversion system 300 can operate on a computer system with a central processing unit 301, I/O devices 302, and memory 303. The I/O devices may include an Internet connection, a connection to various output devices such as a television, and a connection to various input devices such as a television receiver. The media mapping system may be stored as instructions on a computer-readable medium, such as a disk drive, memory, or data transmission medium. The data structures of the media mapping system may also be stored on a computer-readable medium. The conversion system includes drivers 304, a forwarding component 305, a demux component 306, a label map get component 307, path data structures 308, conversion routines 309, and instance data 310. Each driver receives data in a source format and forwards the data to the forwarding component. The forwarding component identifies the next conversion routine in the path and invokes that conversion routine to process a packet. The forwarding component may invoke the demux component to search for the next conversion routine and add that conversion routine to the path. The demux component may invoke the label map get component to identify the next conversion routine to process the packet. The demux component stores information defining the paths in the path structures. The conversion routines store their state information in the instance data.

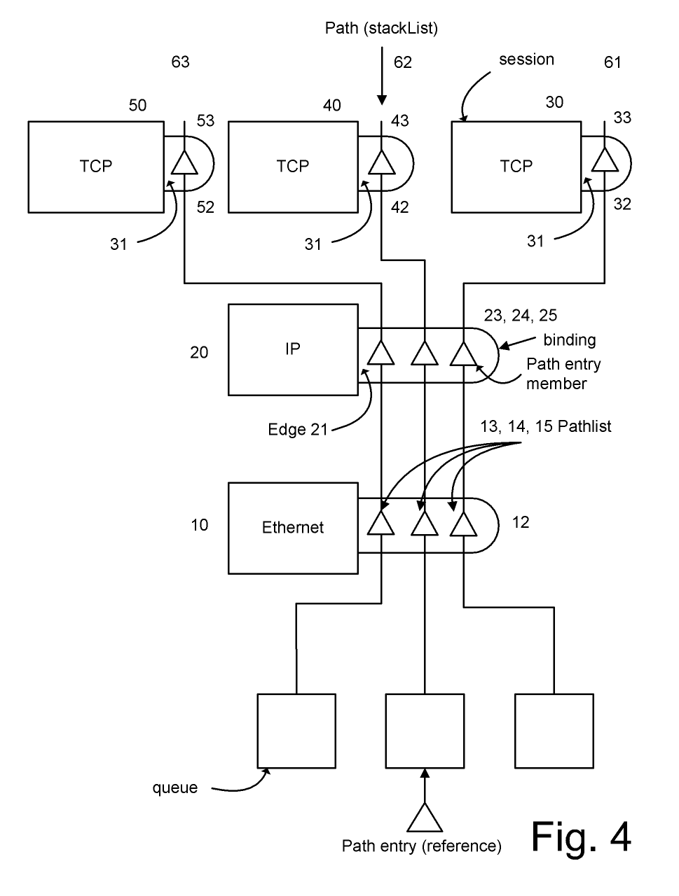

FIG. 4 is a block diagram illustrating example path data structures in one embodiment. The demux component identifies a sequence of “edges” for converting data in one format into another format by invoking the label map get component. Each edge corresponds to a conversion routine for converting data from one format to another. As discussed above, each edge is part of a “protocol” that may include multiple related edges. For example, a protocol may have edges that each convert data in one format into several different formats. Each edge has as an input format (“input label”) and an output format (“output label”). Each rectangle represents a session 410, 420, 430, 440, 450 for a protocol. A session corresponds to an instance of a protocol. That is, the session includes the protocol and state information associated with that instance of the protocol. Session 410 corresponds to a session for an Ethernet protocol; session 420 corresponds to a session for an IP protocol; and sessions 430, 440, 450 correspond to sessions for a TCP protocol. FIG. 4 illustrates three paths 461, 162, 463. Each path includes edges 411, 421, 431. The paths share the same ethernet session 410 and IP session 420, but each path has a unique TCP session 430, 440, 450. Thus, path 461 includes sessions 410, 420, and 430; path 162 includes sessions 410, 420, and 440; and path 463 includes sessions 410, 420, and 450. The conversion system represents each path by a sequence of path entry structures. Each path entry structure is represented by a triangle. Thus, path 461 is represented by path entries 415, 425, and 433. The conversion system represents the path entries of a path by a stack list. Each path also has a queue 471, 472, 473 associated with it. Each queue stores the messages that are to be processed by the conversion routines of the edges of the path. Each session includes a binding 412, 422, 432, 442, 452 that is represented by an oblong shape adjacent to the corresponding edge. A binding for an edge of a session represents those paths that include the edge. The binding 412 indicates that three paths are bound (or “nailed”) to edge 411 of the Ethernet session 410. The conversion system uses a path list to track the paths that are bound to a binding. The path list of binding 412 identifies path entries 413, 414, and 415.

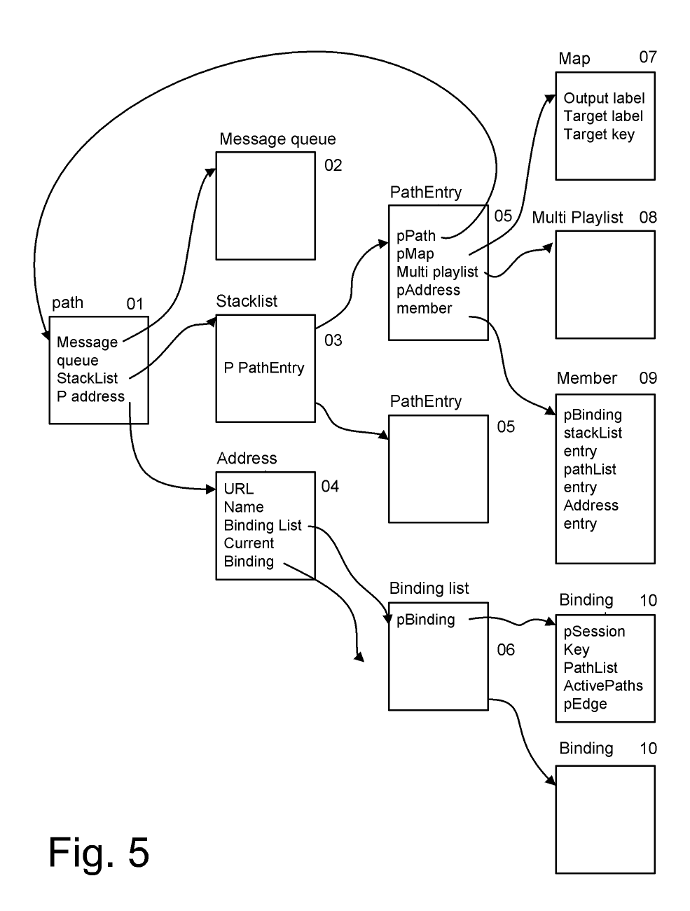

FIG. 5 is a block diagram that illustrates the interrelationship of the data structures of a path. Each path has a corresponding path structure 501 that contains status information and pointers to a message queue structure 502, a stack list structure 503, and a path address structure 504. The status of a path can be extend, continue, or end. Each message handler returns a status for the path. The status of extend means that additional path entries should be added to the path. The status of end means that this path should end at this point and subsequent processing should continue at a new path. The status of continue means that the protocol does not care how the path is handled. In one embodiment, when a path has a status of continue, the system creates a copy of the path and extends the copy. The message queue structure identifies the messages (or packets of a message) that are queued up for processing by the path and identifies the path entry at where the processing should start. The stack list structure contains a list of pointers to the path entry structures 505 that comprise the path. Each path entry structure contains a pointer to the corresponding path data structure, a pointer to a map structure 507, a pointer to a multiplex list 508, a pointer to the corresponding path address structure, and a pointer to a member structure 509. A map structure identifies the output label of the edge of the path entry and optionally a target label and a target key. A target key identifies the session associated with the protocol that converts the packet to the target label. (The terms “media,” “label,” and “format” are used interchangeably to refer to the output of a protocol.) The multiplex list is used during the demux process to track possible next edges when a path is being identified as having more than one next edge. The member structure indicates that the path entry represents an edge of a path and contains a pointer to a binding structure to which the path entry is associated (or “nailed”), a stack list entry is the position of the path entry within the associated stack list, a path list entry is the position of the path entry within the associated path list of a binding and an address entry is the position of the binding within the associated path address. A path address of a path identifies the bindings to which the path entries are bound. The path address structure contains a URL for the path, the name of the path identified by the address, a pointer to a binding list structure 506, and the identification of the current binding within the binding list. The URL (e.g., “protocol://tcp(0)/ip(0)/eth(0)”) identifies conversion routines (e.g., protocols and edges) of a path in a human-readable format. The URL (universal resource locator) includes a type field (e.g., “protocol”) followed by a sequence of items (e.g., “tcp(0)”). The type field specifies the format of the following information in the URL that specifies that the type field is followed by a sequence of items. Each item identifies a protocol and an edge (e.g., the protocol is “tcp” and the edge is “0”). In one embodiment, the items of a URL may also contain an identifier of state information that is to be used when processing a message. These URLs can be used to illustrate to a user various paths that are available for processing a message. The current binding is the last binding in the path as the path is being built. The binding list structure contains a list of pointers to the binding structures associated with the path. Each binding structure 510 contains a pointer to a session structure, a pointer to an edge structure, a key, a path list structure, and a list of active paths through the binding. The key identifies the state information for a session of a protocol. A path list structure contains pointers to the path entry structures associated with the binding.

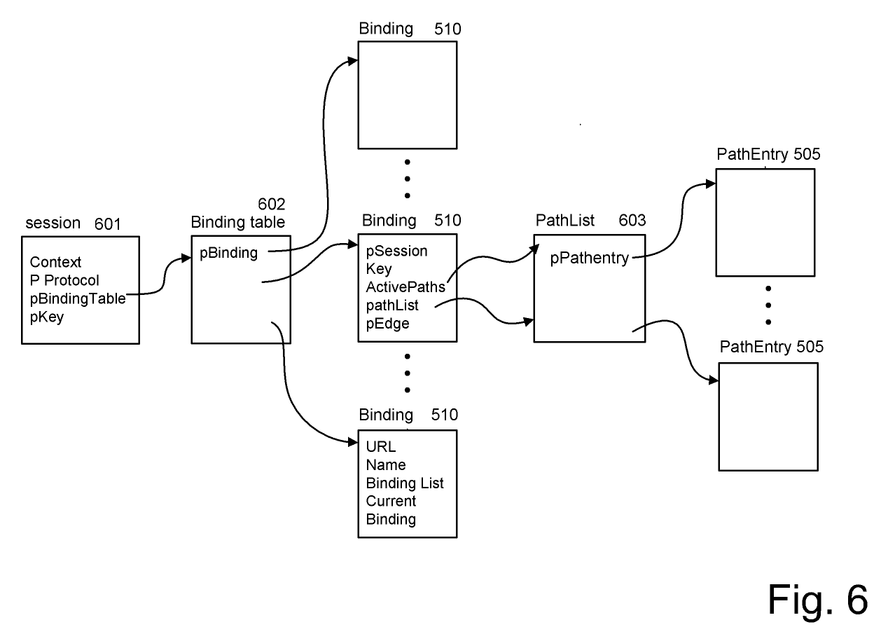

FIG. 6 is a block diagram that illustrates the interrelationship of the data structures associated with a session. A session structure 601 contains the context for the session, a pointer to a protocol structure for the session, a pointer to a binding table structure 602 for the bindings associated with the session, and the key. The binding table structure contains a list of pointers to the binding structures 510 for the session. The binding structure is described above with reference to FIG. 5. The path list structure 603 of the binding structure contains a list of pointers to path entry structures 505. The path entry structures are described with reference to FIG. 5.

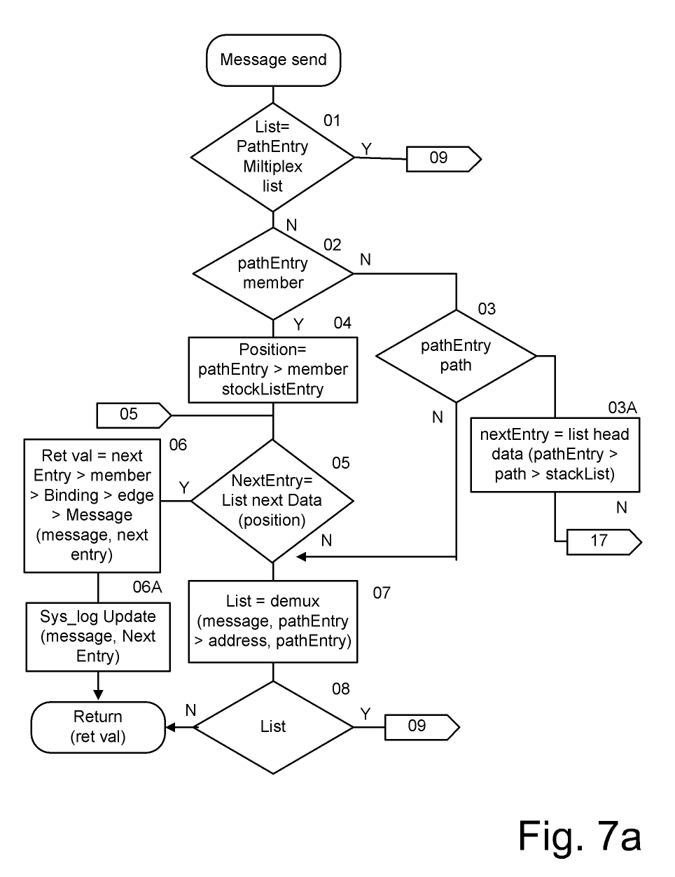

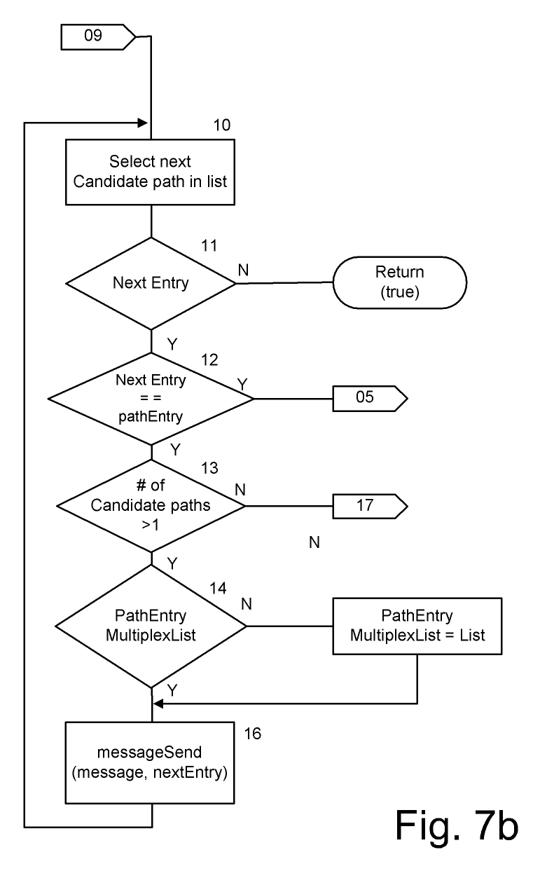

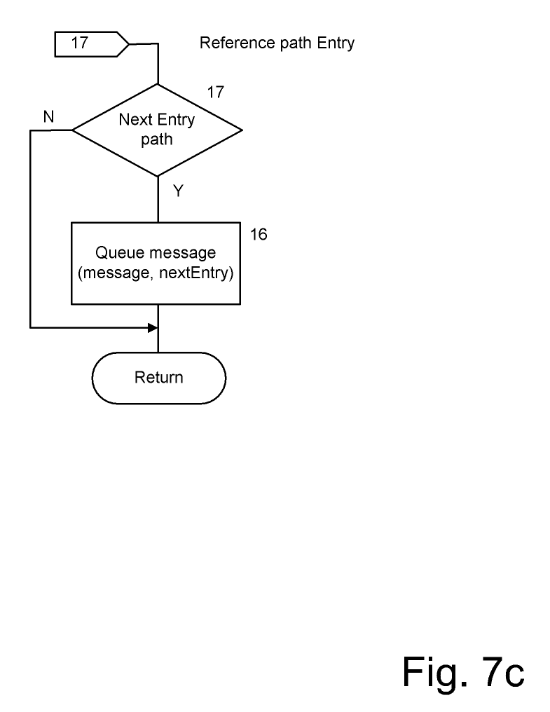

FIGS. 7A, 7B, and 7C comprise a flow diagram illustrating the processing of the message send routine. The message send routine is passed a message along with the path entry associated with the session that last processed the message. The message send routine invokes the message handler of the next edge in the path or queues the message for processing by a path. The message handier invokes the demux routine to identify the next path entry of the path. When a driver receives a message, it invokes the message send routine passing a reference path entry. The message send routine examines the passed path entry to determine (1) whether multiple paths branch from the path of the passed path entry, (2) whether the passed path entry is a reference with an associated path, or (3) whether the passed path entry is a member with a next path entry. If multiple paths branch from the path of the passed path entry, then the routine recursively invokes the message send routine for each path. If the path entry is a reference with an associated path, then the driver previously invoked the message send routine, which associated a path with the reference path entry, and the routine places the message on the queue for the path. If the passed path entry is a member with a next path entry, then the routine invokes the message handler (i.e., conversion routine of the edge) associated with the next path entry. If the passed path entry is a reference without an associated path or is a member without a next path entry, then the routine invokes the demux routine to identify the next path entry. The routine then recursively invokes the messages send routine passing that next path entry. In decision block 701, if the passed path entry has a multiplex list, then the path branches off into multiple paths and the routine continues at block 709, else the routine continues at block 702. A packet may be processed by several different paths. For example, if a certain message is directed to two different output devices, then the message is processed by two different paths. Also, a message may need to be processed by multiple partial paths when searching for a complete path. In decision block 702, if the passed path entry is a member, then either the next path entry indicates a nailed binding or the path needs to be extended and the routine continues at block 704, else the routine continues at block 703. A nailed binding is a binding (e.g., edge and protocol) is associated with a session. In decision block 703, the passed path entry is a reference and if the passed path entry has an associated path, then the routine can queue the message for the associated path and the routine continues at block 703A, else the routine needs to identify a path and the routine continues at block 707. In block 703A, the routine sets the entry to the first path entry in the path and continues at block 717. In block 704, the routine sets the variable position to the stack list entry of the passed path entry. In decision block 705, the routine sets the variable next entry to the next path entry in the path. If there is a next entry in the path, then the next session and edge of the protocol have been identified and the routine continues at block 706, else the routine continues at block 707. In block 706, the routine passes the message to the message handler of the edge associated with the next entry. In block 706A, the routine invokes to log update routine to log information relating to the processing of the message and then returns. In block 707, the routine invokes the demux routine passing the passed message, the address of the passed path entry, and the passed path entry. The demux routine returns a list of candidate paths for processing of the message. In decision block 708, if at least one candidate path is returned, then the routine continues at block 709, else the routine returns.

Blocks 709-716 illustrate the processing of a list of candidate paths that extend from the passed path entry. In blocks 710-716, the routine loops selecting each candidate path and sending the message to be process by each candidate path. In block 710, the routine sets the next entry to the first path entry of the next candidate path. In decision block 711, if all the candidate paths have not yet been processed, then the routine continues at block 712, else the routine returns. In decision block 712, if the next entry is equal to the passed path entry, then the path is to be extended and the routine continues at block 705, else the routine continues at block 713. The candidate paths include a first path entry that is a reference path entry for new paths or that is the last path entry of a path being extended. In decision block 713, if the number of candidate paths is greater than one, then the routine continues at block 714, else the routine continues at block 718. In decision block 714, if the passed path entry has a multiplex list associated with it, then the routine continues at block 716, else the routine continues at block 715. In block 715, the routine associates the list of candidate path with the multiplex list of the passed path entry and continues at block 716. In block 716, the routine sends the message to the next entry by recursively invoking the message send routine. The routine then loops to block 710 to select the next entry associated with the next candidate path.

Blocks 717-718 are performed when the passed path entry is a reference path entry that has a path associated with it. In block 717, if there is a path associated with the next entry, then the routine continues at block 718, else the routine returns. In block 718, the routine queues the message for the path of the next entry and then returns.

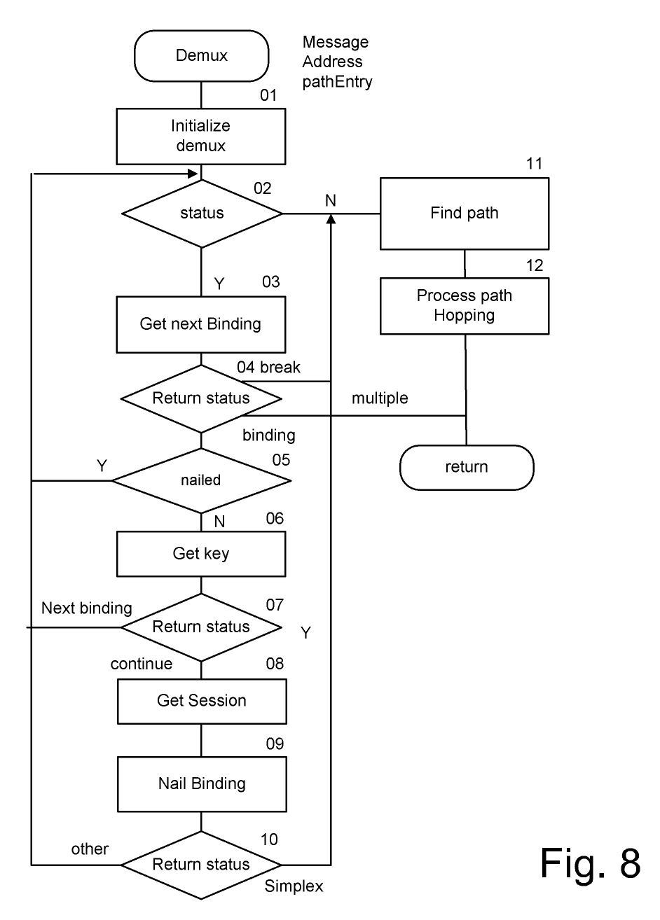

FIG. 8 is a flow diagram of the demux routine. This routine is passed the packet (message) that is received, an address structure, and a path entry structure. The demux routine extends a path, creating one if necessary. The routine loops identifying the next binding (edge and protocol) that is to process the message and “nailing” the binding to a session for the message, if not already nailed. After identifying the nailed binding, the routine searches for the shortest path through the nailed binding, creating a path if none exists. In block 801, the routine invokes the initialize demux routine. In blocks 802-810, the routine loops identifying a path or portion of a path for processing the passed message. In decision block 802, if there is a current status, which was returned by the demux key routine that was last invoked (e.g., continue, extend, end, or postpone), then the routine continues at block 803, else the routine continues at block 811. In block 803, the routine invokes the get next binding routine. The get next binding routine returns the next binding in the path. The binding is the edge of a protocol. That routine extends the path as appropriate to include the binding. The routine returns a return status of break, binding, or multiple. The return status of binding indicates that the next binding in the path was found by extending the path as appropriate and the routine continues to “nail” the binding to a session as appropriate. The return status of multiple means that multiple trails (e.g., candidate paths) were identified as possible extensions of the path. In a decision block 804, if the return status is break, then the routine continues at block 811. If the return status is multiple, then the routine returns. If the return status is binding, then the routine continues at block 805. In decision block 805, if the retrieved binding is nailed as indicated by being assigned to a session, then the routine loops to block 802, else the routine continues at block 806. In block 806, the routine invokes the get key routine of the edge associated with the binding. The get key routine creates the key for the session associated with the message. If a key cannot be created until subsequent bindings are processed or because the current binding is to be removed, then the get key routine returns a next binding status, else it returns a continue status. In decision block 807, if the return status of the get key routine is next binding, then the routine loops to block 802 to get the next binding, else the routine continues at block 808. In block 808, the routine invokes the routine get session. The routine get session returns the session associated with the key, creating a new session if necessary. In block 809, the routine invokes the routine nail binding. The routine nail binding retrieves the binding if one is already nailed to the session. Otherwise, that routine nails the binding to the session. In decision block 810, if the nail binding routine returns a status of simplex, then the routine continues at block 811 because only one path can use the session, else the routine loops to block 802. Immediately upon return from the nail binding routine, the routine may invoke a set map routine of the edge passing the session and a map to allow the edge to set its map. In block 811, the routine invokes the find path routine, which finds the shortest path through the binding list and creates a path if necessary. In block 812, the routine invokes the process path hopping routine, which determines whether the identified path is part of a different path. Path hopping occurs when, for example, IP fragments are built up along separate paths, but once the fragments are built up they can be processed by the same subsequent path.

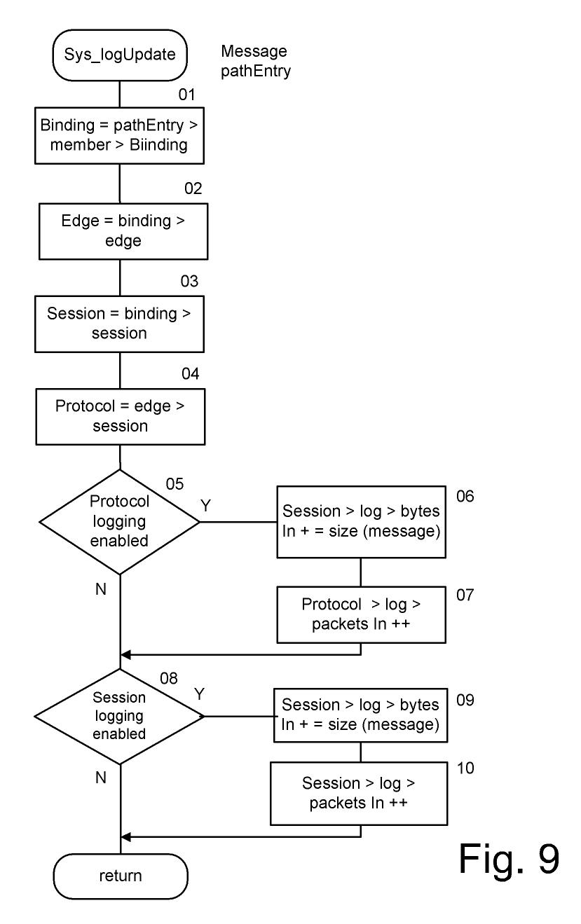

FIGS. 9-13 are flow diagrams illustrating an implementation of the logging system. In this implementation, the logging is independent of the protocols. The protocols do not need to explicitly invoke logging routines. Rather, the message send routine invokes the logging routines through the demux and queue message routines. The process path routine, which remove messages from the message queue and then invokes the message send routine, also invokes the logging routines. FIG. 9 is a flow diagram illustrating the log update routine in one embodiment. The log update routine is responsible for logging messages received for each protocol and each session. The logging at the protocol or session level can be selectively enabled or disabled for each protocol or session. The routine is passed the message along with a path entry corresponding to that message and is invoked by the message send routine either before or after the conversion routine is invoked. Each protocol may implement further logging at the edge, binding, or path entry levels. Each protocol and session has an associated log data structure for storing the logging information. The logging information may include the number of bytes and the number of packets processed by a protocol. In block 901, the routine identifies the binding structure associated with the passed path entry. In block 902, the routine retrieves the edge data structure associated with the identified binding structure. In block 903, the routine retrieves the session data structure associated with the identified binding structure. In block 904, the routine retrieves the protocol data structure associated with the retrieved edge data structure. In decision block 905, if protocol logging is enabled, then the routine continues at block 906, else the routine continues at block 908. The protocol data structure may contain a flag indicating whether logging is enabled for the protocol. That flag can be set when the protocol data structure is initialized. In block 906, the routine increases the number of bytes processed by the protocol by the size of the message. In block 907, the routine increments the number of packets processed by the protocol. In block 908, if session logging is enabled, then routine continues at block 909, else the routine returns. In block 909, the routine increases the number of bytes processed by the associated session by the size of the message. In block 910, the routine increments the number of packets processed by the session associated with the path entry. The routine returns.

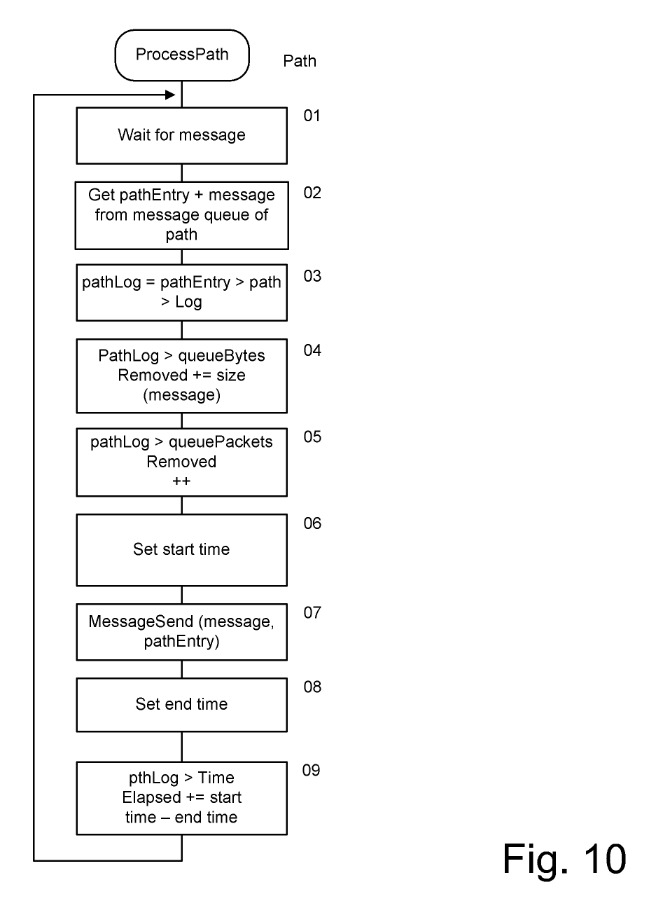

FIG. 10 is a flow diagram of the process path routine in one embodiment. The process path routine loops waiting for messages to be placed in the message queue for the path. When a message is in the message queue, the routine retrieves the message, logs the message, and forwards the message to be processed by the protocols associated with a path. Each path has an associated thread that executes the process path routine. Each path has an associated log data structure for storing the number of bytes and packets added to and removed from the message queue for the path. In addition, the data structure may contain timing information indicating how long it is taking to process a message. In block 1001, the routine waits for a message to be placed in the message queue. In block 1002, the routine retrieves the path entry and message from the message queue. In block 1003, the routine retrieves the log data structure for the path. In block 1004, the routine updates the log data structure to reflect the number of bytes that have been removed from the message queue. In block 1005, the routine updates the log data structure to reflect that a packet has been removed from the message queue. In block 1006, the routine sets the start time, which indicates when the messages is sent to the first protocol in the path. In block 1007, the routine invokes the message send routine passing the message and the path entry. The message send routine controls the forwarding of the message to each protocol in the path. In block 1008, the routine sets the end time. In block 1009, the routine updates the log data structure to indicate the time that elapsed in processing the message. The elapsed time is the time between the invocation of and returning of the message send routine. This timing information can also be used to determine whether a certain path needs to have more computer resources (e.g., CPU time and memory) allocated to it. The routine then loops to block 1001 to wait for the next message.

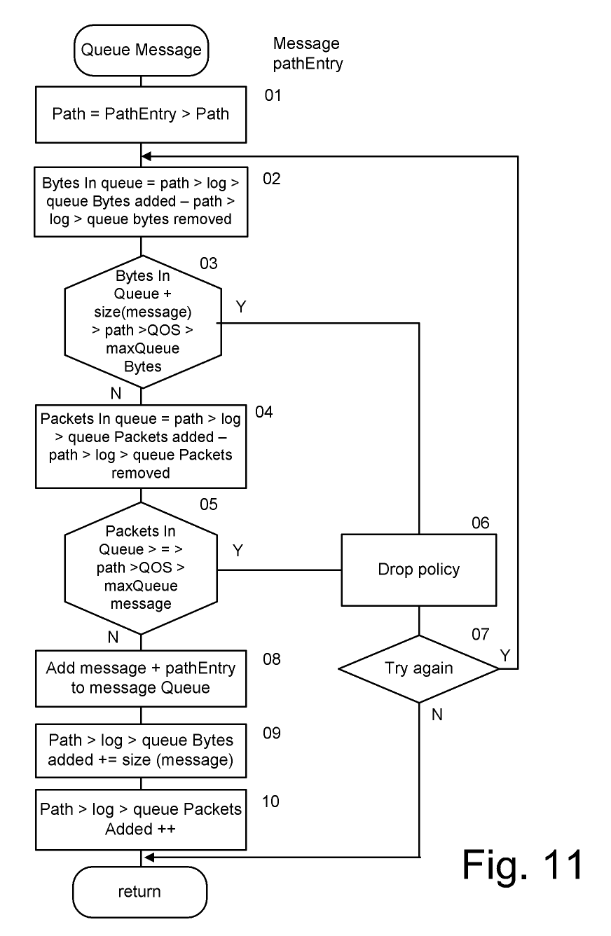

FIG. 11 is a flow diagram of the queue message routine in one embodiment. The routine is passed a message and a path entry data structure. The routine adds the message to the message queue for the path. If the message queue is a full, the routine then implements a policy for dropping messages. In particular, the routine may drop the oldest message to make room for the new message, may drop the newest message, or wait until a message is removed from the message queue in the normal course of processing. The routine also logs information relating to the adding of the message to the message queue. In block 1101, the routine retrieves the path data structure associated with the passed path entry. In block 1102, the routine determines the total number of bytes in the messages that are currently in the message queue. In decision block 1103, if there is not enough room in the message queue for the new message, then the routine continues at block 1106, else the routine continues at block 1104. In block 1104, the routine determines the total number of messages (packets) that are currently in the message queue. In decision block 1105, if there is not enough room in the message queue for one more message, then the routine continues at block 1106, else the routine continues at block 1108. In block 1106, the routine invokes the drop policy routine, which implements the drop policy. In decision block 1107, if the drop policy routine indicates to try adding that message to the message queue again, then the routine loops to block 1102, else the routine returns. In block 1108, the routine adds the message and path entry to the message queue. In block 1109, the routine updates the log data structure for the path to indicate the number of bytes added to the message queue. In block 1110, the routine updates the log data structure to indicate that a packet has been added to the message queue. The routine then returns.

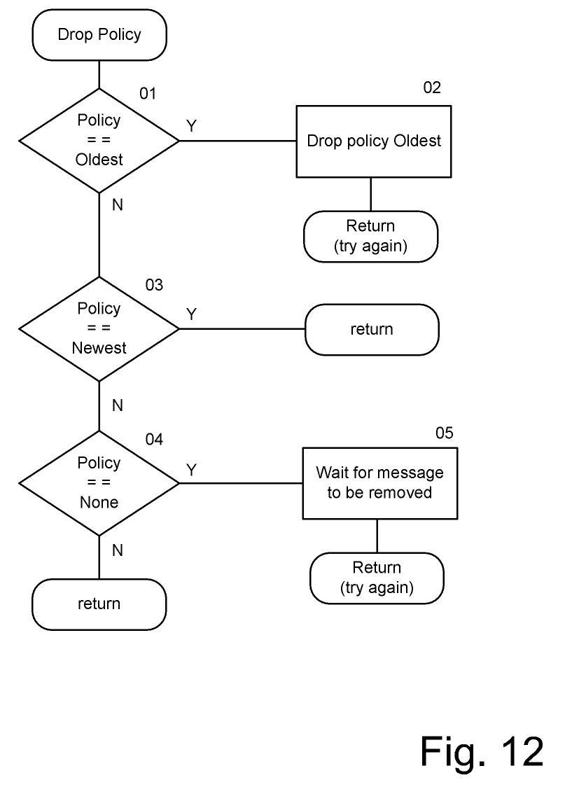

FIG. 12 is a flow diagram of the drop policy routine. The drop policy routine identifies the drop policy for the path and implements that policy. In decision block 1201, if the policy is to drop the oldest message, then the routine continues at block 1202, else the routine continues at block 1203. In block 1202, the routine invokes the drop policy oldest routine, which implements the policy of dropping the oldest message. The routine then returns an indication to try adding the new message to the message queue. In decision block 1203, if the policy is to drop the newest message, then the routine returns, else the routine continues at block 1204. In decision block 1204, if the policy is not to drop any messages, then the routine continues at block 1205, else the routine returns. In block 1205, the routine waits for a message to the removed from the message queue during normal processing. The routine then returns an indication to try adding the new message to the message queue.

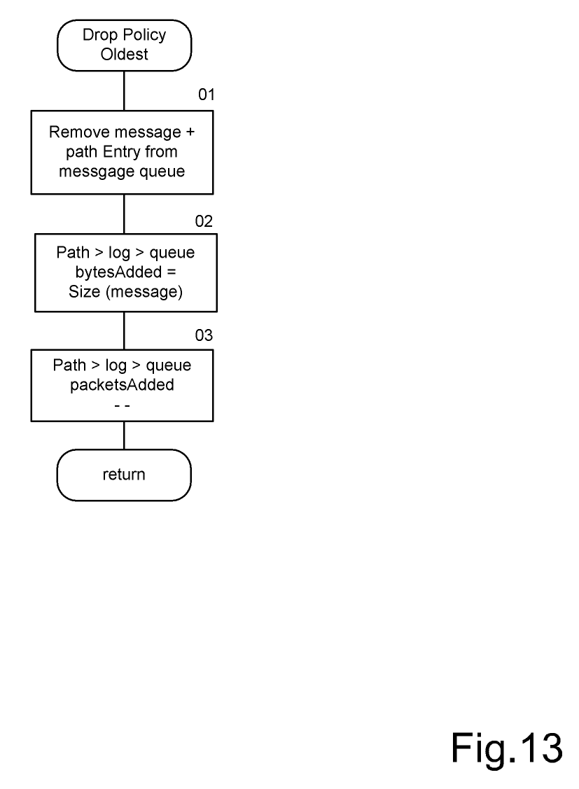

FIG. 13 is a flow diagram of the drop policy oldest routine. This routine removes the oldest message from the message queue. In block 1301, the routine removes a message and its path entry from the message queue. In block 1302, the routine updates the log data structure of the path to decrement the number of bytes of the message that have been added to a message queue. In block 1303, the routine updates the log data structure to indicate that one less message has been added to the message queue. The routine then returns.

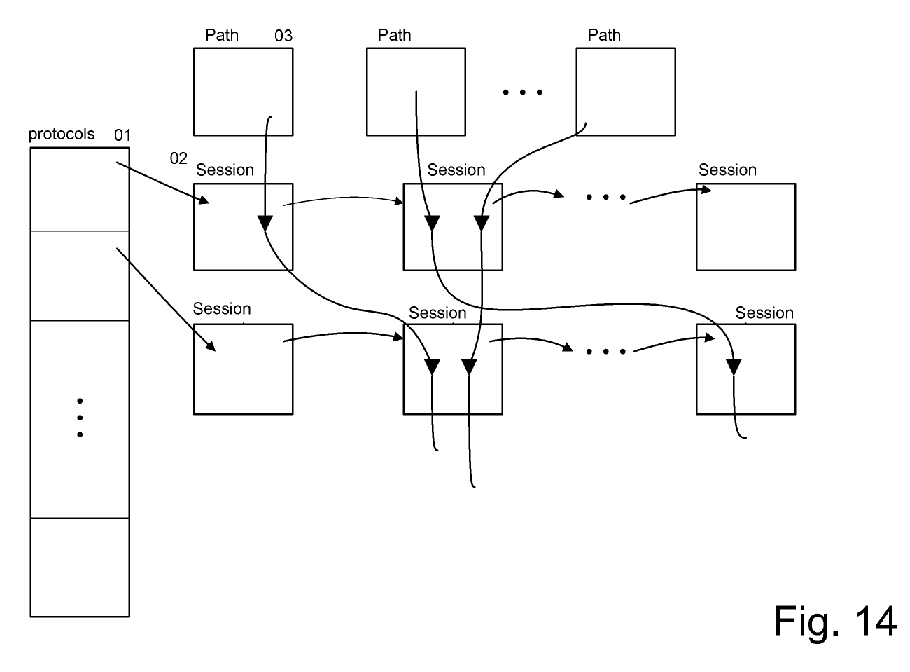

FIG. 14 is a block diagram illustrating a data structure for storing logging information persistently in one embodiment. The logging system may log information at the protocol level, session level, and path level. Each protocol may have a protocol logging data structure 1401 with links to a session logging data structure 1402 for each session associated with that protocol. Each path may have a path logging data structure 1403 with links to the session logging data structures associated with that path. The logging system may periodically transfer the collected logging information to the persistent data structure. In addition, the information may be transferred whenever a protocol, session, or path is destructed. Alternatively, the system may access a combination of the in-memory data structures storing the most recent logging information and the persistent data structures.

Although the conversion system has been described in terms of various embodiments, the invention is not limited to these embodiments. Modification within the spirit of the invention will be apparent to those skilled in the art. The scope of the invention is defined by the claims that follow.

I/We claim:

1. A method in a computer system for logging data, the method comprising:
selecting a sequence of components for processing the data, each component having an input format and an output format such that the output format of a component is compatible with the input format of the next component in the sequence;
invoking each of the components in sequence wherein output data of a component is input data for the next component in the sequence; and
recording amount of data processed by each component.

2. The method of claim 1 including recording type of data processed by each component.

3. The method of claim 1 wherein a mapping from components to the recorded amount of data is used to determine a fee for the processing of the data.

4. The method of claim 1 wherein the components are protocols and the amount of data is recorded at the protocol level.

5. The method of claim 1 wherein the components are protocols with sessions and the amount of data is recorded at the session level.

6. The method of claim 1 wherein the components are protocols with edges and the amount of data is recorded at the edge level.

7. The method of claim 1 wherein the amount of data processed by a path is recorded.

8. The method of claim 1 including recording processing time of the data.

9. The method of claim 1 wherein a source of the data is identifiable from the recorded data.

10. The method of claim 1 wherein the recorded information is used to identify sources of advertisements.

11. The method of claim 1 wherein a source of data is uniquely identifiable from a component that processes the data.

12. The method of claim 1 including recording processing time of a component and allocating computer system resources based on the recorded processing time.

13. A method in a computer system for billing for processing of data, the method comprising:
identifying a sequence of components for processing the data based on a source format of the data and a target format of the data;
logging amount of data processed by each component in the sequence; and
determining a price for the processing based on the logged amount processed by a component.

14. The method of claim 13 including logging of processing time of each component.

15. The method of claim 13 wherein a component in the sequence uniquely identifies a source of the data.

16. The method of claim 13 wherein the data is an advertisement.

17. The method of claim 13 wherein the component is a protocol.

18. The method of claim 13 wherein the logging at either the session or path level.

19. A method in a computer system for identifying a source of data, the method comprising:
identifying a sequence of components for processing that data; and
invoking each of the components in sequence wherein one component uniquely identifies the source of the data and wherein the amount of data associated with the identified source is logged.

20. The method of claim 19 including billing based on the identified source.

21. The method of claim 19 wherein the data is an advertisement provided by the identified source.

22. The method of claim 19 including logging timing information.

23. The method of claim 22 wherein computer resources are allocated to the components based on the logged timing information.

24. The method of claim 23 wherein the computer resource is a central processing unit.

25. The method of claim 23 wherein the computer resource is memory.
